(19) United States
(12) Patent Application Publication
(10) Pub. No.: US 2009/0192822 A1
(43) Pub. Date: Jul. 30, 2009

(54) METHODS AND COMPUTER PROGRAM PRODUCTS FOR NATURAL LANGUAGE PROCESSING FRAMEWORK TO ASSIST IN THE EVALUATION OF MEDICAL CARE

(75) Inventors: Sushmitha Regulapati, Greendale, WI (US); Vasudevan Jagannathan, Morgantown, WV (US); Henry Ware, Morgantown, WV (US)

Correspondence Address: BUCHANAN, INGERSOLL & ROONEY PC, POST OFFICE BOX 1404, ALEXANDRIA, VA, 22313-1404, US

(73) Assignee: MedQuist Inc., Mt. Laurel, NJ (US)

(21) Appl. No.: 12/265,495

(22) Filed: Nov. 5, 2008

Related U.S. Application Data
(60) Provisional application No. 60/996,172, filed on Nov. 5, 2007.

(51) Int. Cl. G06Q 50/00; G06Q 10/00; G06F 17/30; G06N 5/02

(52) U.S. Cl. 705/3; 707/3; 707/E17.014; 706/47

(57) ABSTRACT

A computerized method for evaluating medical reports includes identifying at least one or more medical reports stored in a database related to the medical condition, validating the identified medical reports by determining if key words associated with the medical condition found in the at least one or more reports are surrounded by a negative context and extracting relevant data from the medical reports. The exemplary method also includes evaluating the relevant data from the medical reports with provisions set forth in clinical guidelines corresponding to a medical condition, storing a flag identifying one or more of the medical reports as noncompliant when its corresponding relevant data does not comply with the provisions set forth in the clinical guideline unless a valid contraindication applies and displaying the medical reports identified as noncompliant.

### FIELD

The present disclosure relates generally to natural language processing of textual data, and more particularly to the application of natural language processing in the area of healthcare.

### BACKGROUND

Patient safety is an important aspect of quality healthcare. The Institute of Medicine has recommended the use of clinical guidelines in improving patient safety. Clinical guidelines are systematically developed statements for practitioners and patients about appropriate health care for specific clinical circumstances.

One potential use of clinical guidelines in the field of healthcare is to embed the guidelines in an electronic health record. However, contemporary health care is largely delivered without the benefit of computerized physician order entry and rule-based alerts and reminders. Many healthcare programs are undertaken through retrospective manual chart review with subsequent re-education of the clinicians. This process can lead to substandard care being delivered since the possibility of human error may occur.

Natural language processing (NLP) technology has a long history in computer science and is an active area of research in healthcare. Often, clinical information generated by physician dictation is stored as free text in a transcribed document. The free text cannot be readily accessed by automated applications. Using natural language processing techniques, locked up information within the free text can be extracted for analyses and accessed by automated applications.

Some prior patent references attempt to use NLP technology to improve some aspect of healthcare. For instance, U.S. Pat. No. 6,292,771 to Haug et al. discloses a natural language understanding system in which free text data is transformed to coded data for use in the encoding of free-text diagnoses and for the encoding of x-ray reports for the purpose of storing concepts in a medical database.

The disclosed methods and computer program products for natural language processing framework are directed toward, but not limited to, improving the above-noted methods for natural language processing in the area of healthcare.

### SUMMARY

Exemplary embodiments disclosed herein provide methods and computer program products for natural language processing framework. The method, for example, includes identifying at least one or more medical reports relating to a medical condition, validating the identified medical reports by determining if key words associated with the medical condition found in at least one report is surrounded by a negative context, extracting relevant data from the medical reports, evaluating relevant data from the medical reports with provisions set forth in the clinical guidelines corresponding to the medical condition, storing a flag identifying one or more of the medical reports as noncompliant when its corresponding relevant data does not comply with the provisions set forth in the clinical guidelines, unless a valid contraindication applies, and displaying the medical reports identified as noncompliant and alerting appropriate personnel.

The exemplary method also includes, searching data in medical reports stored in a storage device using a selected group of words to identify at least one or more concepts, extracting data from the medical reports, determining the context of an identified concept, tagging the identified concepts with a qualifier to characterize the context of the concept, applying a set of rules to the data to determine medical conditions when a concept has not been identified and determining the medical condition based on the results of searching, determining and tagging or based on the result of application of the rules.

### BRIEF DESCRIPTION OF THE DRAWINGS

FIG. 1 is a block diagram illustrating an exemplary first embodiment of a NLP system as disclosed herein;

FIG. 2 is an exemplary illustration of a portion of an XML representation of a clinical guideline;

FIG. 3. is a flowchart diagram illustrating an exemplary representation of adherence to the clinical guidelines as disclosed herein;

FIG. 4 is a block diagram illustrating an exemplary second embodiment of a NLP system as disclosed herein; and

FIG. 5 is a flowchart diagram illustrating an exemplary representation of evaluating data.

### DETAILED DESCRIPTION

The present disclosure describes a natural language processing system for ensuring adherence to clinical guidelines and for determining medical conditions. Although, some of the exemplary embodiments are tailored for congestive heart failure to facilitate describing certain aspects of the invention, the present invention is not limited to this example. The present invention can be used for any medical condition, such as, asthma, CAD, depression, diabetes, gallstones, GERD, gout, hypercholesterolemia, hypertension, hypertriglyceridemia, OA, obesity, OSA and PVD.

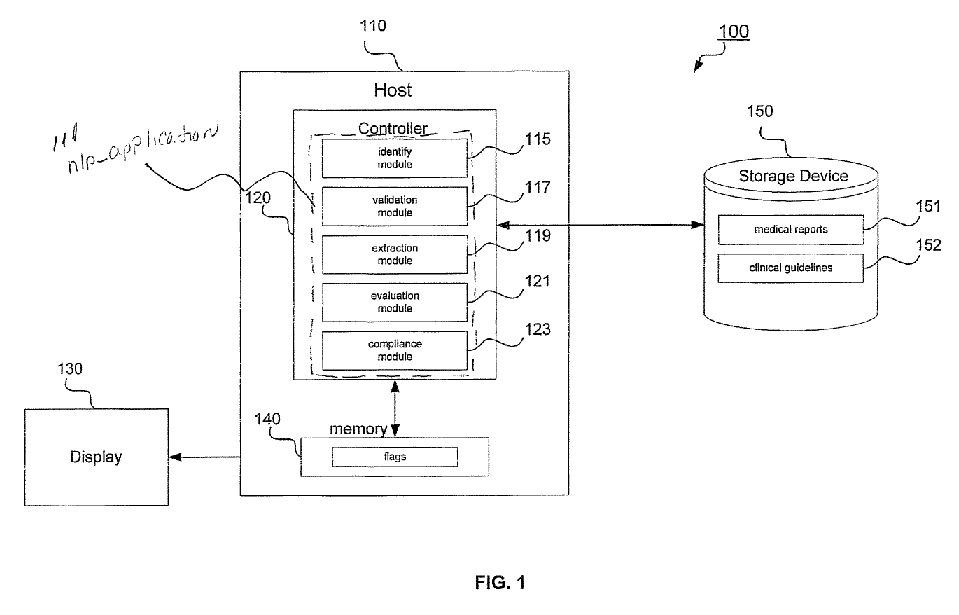

FIG. 1 is a block diagram illustrating a system environment 100 for evaluating medical reports that is consistent with some exemplary embodiments. In system environment 100, a host (e.g., host 110) includes a controller (e.g., controller 120) which accesses data from a storage device (e.g., storage device 150). The accessed data (e.g., medical reports) is analyzed using modules (e.g., modules 115-123) to determine compliance with clinical guidelines.

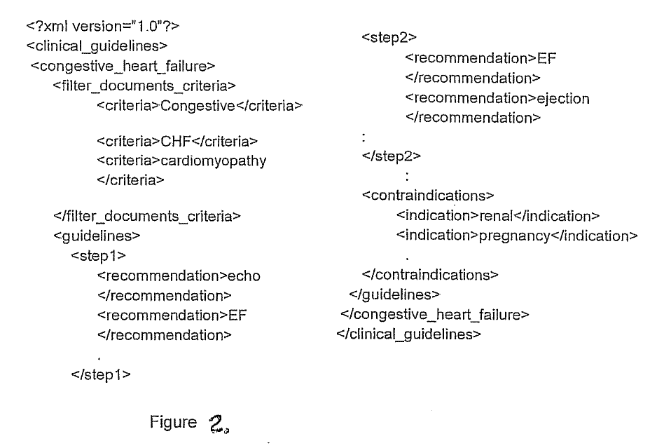

The clinical guidelines are stored in a database as electronic health records on the storage device for access by the host. The guidelines are embedded as electronic health records using the Extensible Markup Language (XML), as illustrated in FIG. 2. The electronic records include tags for filtering documents relevant to a medical condition, steps of the guidelines, and also a special tag for contraindications. The element contents of the tags have the keywords of the guidelines.

In FIG. 2, the tags for filtering documents relevant to a medical condition (e.g. congestive heart failure) are illustrated as <criteria> Congestive</criteria>, <criteria> CHF</criteria>, <criteria> cardiomyopathy </criteria>. The tags for the steps of the guidelines for congestive heart failure are illustrated as <step 1>, <recommendation> echo </recommendation>, <recommendation >EF </recommendation>, <step 2>, <recommendation> EF </recommendation>, <recommendation> ejection </recommendation>. The special tag for contraindications is illustrated as <indication> renal </indication>, <indication>pregnancy</indication.

The medical reports are stored in a database on the storage device for access by the host. A medical report can be any document relating to a patient's care, including, for example, discharge summaries and admission reports. The medical records can be stored as transcribed documents containing free text or any other suitable digital format. The free text in the document is accessed using NLP technology. Controller 120 performs NLP processing by executing application 111.

An exemplary system environment 100 can include a system that searches the medical reports stored in the storage device to identify medical reports relating to a specific medical condition. The reports identified are checked to determine if keywords relating to the medical condition are described as not being present by determining if the keywords are surrounded by a negative context. The information within the report is evaluated with the information contained in the electronic record associated with the clinical guideline pertaining to the medical condition to determine compliance with the guideline. Although exemplified in the context of clinical guidelines and medical reports, any environment consistent with the present disclosure may benefit from the disclosed methods or systems.

As shown in FIG. 1, exemplary system environment 100 can include a host 110, a storage device 150 and a display 130. Host 110 can be a device or system for receiving, storing, and/or processing data in the storage device 150. Host can be implemented as one or more computer systems including, for example, a personal computer, minicomputer, microprocessor, workstation, mainframe, or similar computing platform.

The host can include a controller 120, memory 140, and an associated storage device 150. Controller 120 can include one or more microprocessors, computer readable memory (e.g., read-only memory (ROM), random access memory (RAM), mechanisms and structures for performing I/O operations. Controller 120 can execute an operating system for execution on the central processing unit and/or application 111. Memory 140 can be internal or external to controller 120.

As further illustrated by FIG. 1, controller executes nlp_application 111, which includes modules 115-123. The nlp_application is a program which can be developed using any suitable computer programming language, such as, Java and the Scala programming language. Scala is a programming language that supports both object-oriented computing and functional programming.

As described in greater detail hereinafter, the nlp_application is a program which understands documents containing free text. Free text is data readable by humans but not by a computer. The program is able to convert the data into a computer readable format so that the data may be used by other programs to automate applications.

The nlp_application includes an identify module 115 for identifying medical reports related to the medical condition of interest, a validation module 117 for validating that the identified medical report is relevant, an extraction module 119 for extracting relevant data from the identified report, an evaluation module 121 for evaluating the relevant data with the provisions set forth in the clinical guideline corresponding to the medical condition and a compliance module 123 for identifying the medical reports as noncompliant when the evaluation module indicates that the data was inconsistent with the provisions of the guidelines.

Memory device 140 can include, for instance, magnetic tapes, magnetic discs, semiconductor-based memories (e.g., random access memory, or flash memory). The memory device stores a flag for each medical report in the database. The flag is set to ‘1’ when the corresponding medical report is noncompliant with the guidelines.

Storage device 150 can store application 111 that, when executed by controller 120, performs the process for determining compliance with the guidelines. Storage device 150 can be implemented with a variety of components or subsystems including, for example, a magnetic disk drive, an optical drive, flash memory, or other devices capable of persistently storing information.

Although data storage device 150 is shown external to the host 110, the location is merely exemplary. Controller 120 and data storage device 150 can be physically located inside or outside of host 110. For instance, data storage device 150 can be configured as a network accessible storage located remotely from controller 120.

As further illustrated in FIG. 1, storage device 150 includes a first database 151 storing medical reports and second database 152 storing XML formatted clinical guidelines. Display device 130 can be any device for outputting information for visual reception, such as, for example, a computer monitor. The display device outputs a noncompliant medical record with pertinent text highlighted for a user.

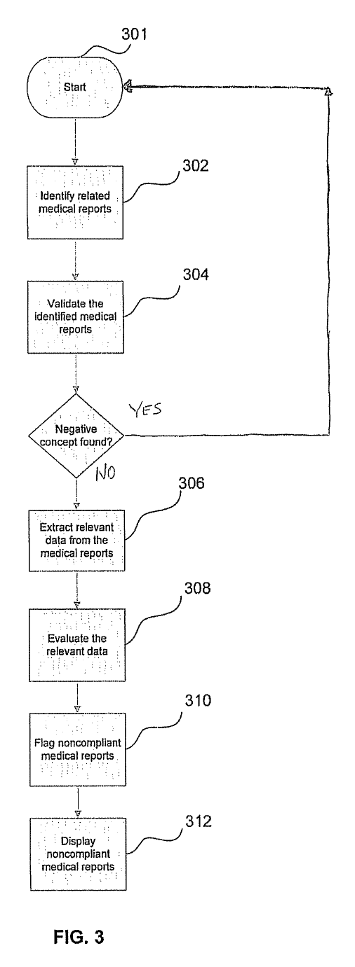

Controller 120 performs natural language processing by executing application 111 which performs the steps illustrated in FIG. 3. The controller retrieves an electronic health record from the storage device corresponding to a particular medical condition (e.g., congestive heart failure). The electronic health record contains keywords relating to the medical condition as illustrated in FIG. 2.

Referring to FIG. 3, identify module 115 searches the medical report database using the keywords to identify medical reports relating to the medical condition (i.e., step 302). For example, to find medical reports related to congestive heart failure, the identify module will search the medical reports in database 151 using keywords “CHF”, “cardiomyopathy”, and “Congestive” as provided by the guideline for congestive heart failure. Any reports containing any of the keywords will be identified as reports relating to congestive heart failure by forwarding the reports to the validate module. Alternatively, as new medical reports become available during care, the new reports would be scanned to determine applicability to one or more guidelines, as shown above.

The identify module can also, for example, search the medical reports using keywords “EF” or “ejection”. If found, the identify module can check if the keywords have a two digit number whose value is less than 40, which is an indication for congestive heart failure. The same principle can be used to determine concepts with values associated with them, such as, for example, weight of a person, lab values from tests, etc. discussed below.

The validate module 117 determines that the medical reports are relevant by checking to see if the keywords are surrounded by a negative context, (i.e., step 304). For example, words that indicate a negative context, such as, no, denies, no sign of, did not exhibit, absence of, without, not, no evidence of, with no, ruled out and negative for, are searched in the vicinity of the presence of the concept. If the validate module finds a report including, for example, “negative for” cardiomyopathy, the report more than likely indicates that the patient does not have the medical condition and the process returns to start (i.e., 301). Otherwise, the process proceeds to step 306.

In step 306, the extraction module 119 extracts relevant data from the medical reports. For example, the extraction module may extract a list of any prescriptions from the medical report, measurements (e.g., ejection fraction), patient's condition (e.g., pregnant) and the care given to the patient (e.g., echo cardiogram). The relevant data extracted is information needed to evaluate the medical report relative to the clinical guideline.

In step 308, the evaluation module 121 compares the relevant data to the steps included in the clinical guideline. For example, step 1 of the clinical guideline for congestive heart failure, as illustrated in FIG. 2, indicates that an “echo” (i.e., echo cardiogram) is recommended for patients having congestive heart failure. Step 1 also indicates that the patient's value of ejection fraction (EF) should be checked and documented. The evaluation module checks the relevant data for “echo” and for “EF”. The terms are searched for negative contexts to determine if the report indicates “no echo” or “no EF”.

In step 310, the compliance module 123 analyzes the results of the evaluation module to determine if the care documented in the medical report is consistent with the clinical guideline. For example, if the evaluation module indicates that the report indicated “no echo”, the compliance module checks the guidelines to determine whether there are reasons listed as to why an echo should not be done (i.e., a contraindication). If any of those reasons are indicated in the medical report, the report is compliant with the guidelines. Otherwise, the medical report is not compliant and the compliance module sets the medical report's corresponding flag to a ‘1’.

The controller, in step 312, outputs the noncompliant medical reports to display 130. The controller includes a graphical user interface (GUI), which is menu-driven and allows a user to select an option for displaying the medical reports. The medical reports can be displayed, for example, by displaying only the noncompliant medical reports or by displaying all of the medical reports, where each report has an associated tag. The tag identifies the report as compliant or noncompliant. A tag can be any type of identifier which distinguishes a compliant medical report from a noncompliant medical report.

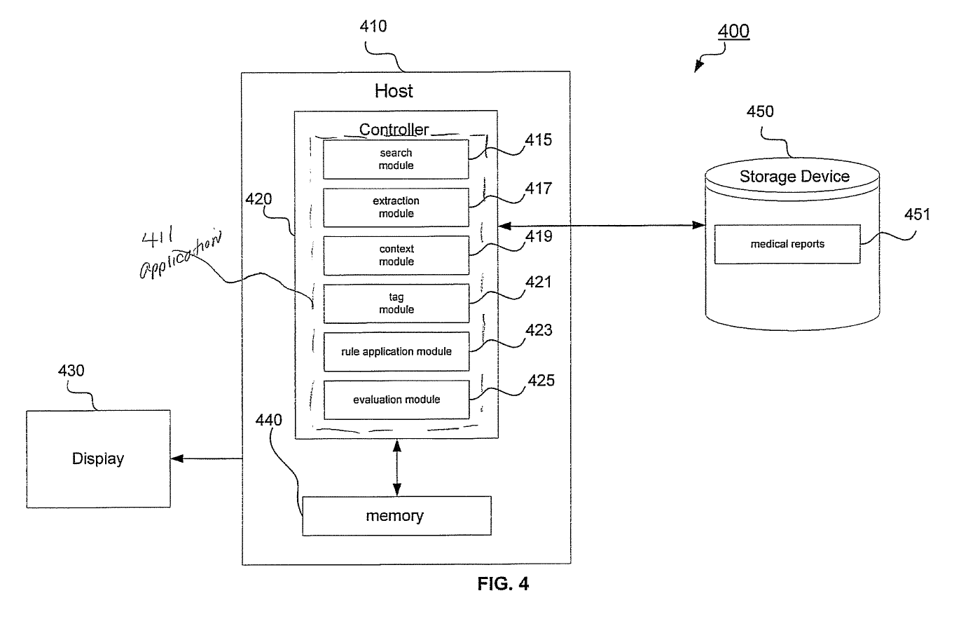

FIG. 4 illustrates another system environment 400 for evaluating medical reports that is consistent with some exemplary embodiments. System 400 includes a host 410, controller 420, memory 440, display 430 and storage device 450, all of which are the same as corresponding elements in FIG. 1. Controller 420 includes application 411, which includes different modules (i.e., 415-425) than the modules (i.e., 115-123) included in nlp_application 111 in system 100.

Storage device 450 includes a database for storing medical reports and can store application 411 that, when executed by controller, performs the process for determining patient medical conditions. Although storage device 450 is shown external to the host 410, the location is merely exemplary. Controller 420 and storage device 450 can be physically located inside or outside of host 410. For instance, data storage device 450 can be configured as a network accessible storage located remotely from controller 420.

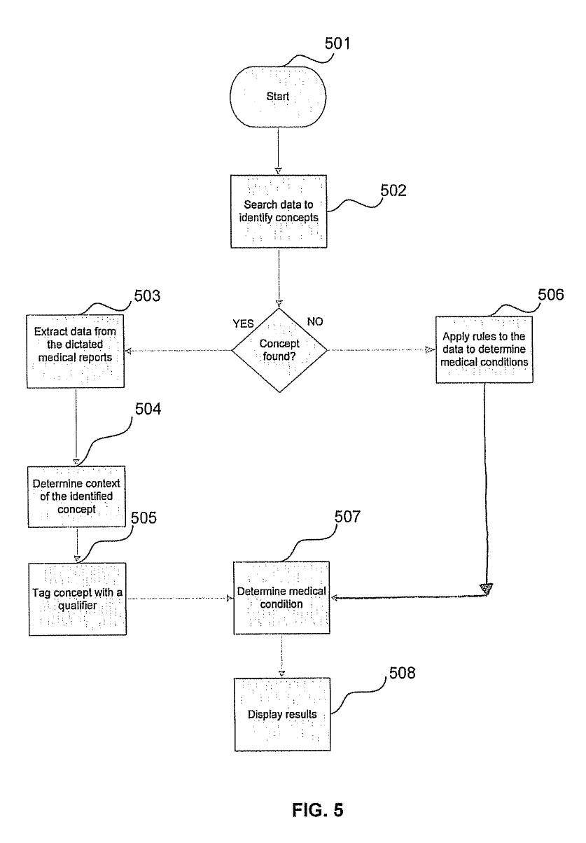

Controller 420 performs natural language processing by executing application 411 which performs the steps illustrated in FIG. 5. Application 411 is a program which can be developed using any suitable computer programming language, such as, Java and the Scala programming language. Scala is a programming language that supports both object-oriented computing and functional programming.

Application 411 combines a textual and intuitive analysis of natural language data (i.e., free text) in the medical reports to determine a patient's medical condition. The textual analysis focuses on keywords included in the document. The intuitive analysis focuses on application of a set of rules. Application 411 includes, a search module 415 for searching the data to identify concepts, an extraction module 417 for extracting data from the medical reports, a context module 419 for determining the context of the concepts, a tag module 421 for tagging the concepts with a qualifier to characterize the context of the concept, a rule application module 423 for applying a set of rules to the data when a concept is not identified by the context module and an evaluation module 425 for determining the medical condition of the patient.

As illustrated in FIG. 5, application 411 begins at step 502 by searching data in a medical report to identify concepts. Controller 420 retrieves a medical report from database 451. Search module 415 searches the data in the medical report using a group of words. The groups of words are terms synonymous with a particular medical condition. For example, terms such as, “coronary artery”, “posterior interventricular artery” and “posterior descending artery” are terms which can be synonymous with the medical condition coronary artery disease (CAD). In this instance, search module searches the medical report for any of the terms within the group. If any of the terms are found in the report, the concept of CAD is identified and application 411 proceeds to step 503. If no concept is identified, application 411 proceeds to step 506.

In step 503, extraction module 417 extracts the terms found in the report by the search module and any surrounding text for further processing by context module 419. The context module determines the context of the concept. In step 504, the context is determined by searching surrounding words of the terms found in step 502 for terms that are associated with a particular context within a sentence fragment. For example, a negated context can be associated with terms such as, no, denies, no sign of, did not exhibit, absence of, without, not, no evidence of, with no, ruled out and negative for.

A similar set of terms are used for a historical context and a hypothetical context and pertaining to relatives of patient context. The context module searches the data for any terms associated with a context. If none of the associated terms are found in the data, tag module 421 will tag the concept with the qualifier natively true for the patient in the current time frame in step 505. In step 505, the concept is tagged negated, hypothetical, historical, pertaining to relatives of patient, or natively true for the patient in the current time frame based on the results of the context module.

If the context module finds words associated with a negated context, the concept is tagged with the qualifier negated, if words are found associated with a historical context, the concept is tagged with the qualifier historical and if words are found that pertain to relatives of patient context, the concept is tagged with the qualifier pertaining to relatives of patient context. The default qualifier is natively true for the patient in the current time frame, which occurs when no words are found associated with the other contexts.

In step 507, evaluation module determines the medical condition of the patient. If the concept is tagged in step 505 as historical, negated or pertaining to relatives of patient, then the concept identified in the medical report is not a medical condition of the patient. However, if the concept is tagged as natively true for the patient in the current frame and the concept also does not have a negated context, then evaluation module determines the medical condition as the concept.

If application 411 does not identify any concepts in the medical report, the program proceeds to step 506. In step 506, rule application module 423 applies a set of rules to the data in the medical report to intuitively assess the medical condition of the patient. For example, the rules can include 1) determining from the data in the medical report if the patient was taking a particular medicine which clearly indicates a particular condition, 2) determining from the data in the medical report if the patient laboratory values for certain measures indicate abnormality and points to a specific condition and 3) determining from the data if ramifications of a particular patient condition is identifiable.

If in step 506, the results indicate that the patient was taking a particular medicine which clearly indicates a particular condition, then evaluation module 425 concludes in step 507, absent any evidence that the medication is being taken for something else, that the condition is present. If the results indicate that the patient's laboratory values for certain measures indicate abnormality and points to a specific condition, then evaluation module concludes that the specific condition is present. If the results indicate that ramifications of a particular condition is identifiable from the data in the medical report, then evaluation module concludes that the particular condition is present. The controller, in step 508, outputs the results to display 430.

Once a medical condition is determined, the patient's records can be checked for adherence to the clinical guidelines for the particular medical condition using nlp_application 111 in FIG. 1.

As disclosed herein, embodiments and features of the invention can be implemented through computer hardware and/or software. Such embodiments can be implemented in various environments, such as networked and computing-based environments with one or more users. The present invention, however, is not limited to such examples, and embodiments of the invention can be implemented with other platforms and in other environments.

Moreover, while illustrative embodiments of the invention have been described herein, further embodiments can include equivalent elements, modifications, omissions, combinations (e.g., of aspects across various embodiments), adaptations and/or alterations as would be appreciated by those in the art based on the present disclosure.

Other embodiments of the invention will be apparent to those skilled in the art from consideration of the specification and practice of the embodiments of the invention disclosed herein. For example, the present invention could be used in the automobile industry to automate adherence to guidelines/checklist for performing mechanical task to automobiles. Further, the steps of the disclosed methods can be modified in various manners, including by reordering steps, executing multiple steps concurrently, and/or inserting or deleting steps, without departing from the principles of the invention. It is therefore intended that the specification and embodiments be considered as exemplary only.

What is claimed is:

1. A method for evaluating medical reports to determine whether care administered to patients adheres to clinical guidelines for a medical condition, comprising:
identifying at least one or more medical reports stored in a database related to the medical condition;
validating the identified medical reports by determining if key words associated with the medical condition found in the at least one or more reports are surrounded by a negative context;
extracting relevant data from the medical reports;
evaluating the relevant data from the medical reports with provisions set forth in the clinical guidelines corresponding to the medical condition;
storing a flag identifying one or more of the medical reports as noncompliant when its corresponding relevant data does not comply with the provisions set forth in the clinical guideline unless a valid contraindication applies; and
displaying the medical reports identified as noncompliant.

2. The method of claim 1, wherein the step of evaluating comprises, comparing the relevant data with the provisions using natural language processing techniques embedded in an extensible markup language (XML) framework.

3. The method of claim 1, wherein the clinical guideline is represented in an extensible markup language (XML) framework.

4. The method of claim 1, wherein a contraindication is a condition requiring deviation from the provisions set forth in the clinical guideline.

5. The method of claim 1, wherein the step of displaying comprises providing a user with display options for displaying the medical reports.

6. The method of claim 5, wherein the display options comprises i) displaying the noncompliant medical reports, or ii) displaying all of the medical reports with an associated tag indicating whether the medical report is noncompliant or not.

7. A computer program product comprising at least one computer-readable storage medium having computer-readable program code portions stored therein for evaluating medical reports to determine whether care administered to patients adheres to clinical guidelines for a medical condition, the computer-readable program code portions comprising:
a first executable portion for identifying at least one or more medical reports relating to the medical condition;
a second executable portion for validating the identified medical reports by determining if key words associated with the medical condition found in the at least one or more reports are surrounded by a negative context;
a third executable portion for extracting relevant data from the medical reports;
a fourth executable portion for evaluating the relevant data from each report with provisions set forth in the clinical guidelines corresponding to the medical condition; and
a fifth executable portion for storing a flag identifying one or more of the medical reports as noncompliant when its corresponding relevant data does not comply with the provisions set forth in the clinical guideline unless a valid contraindication applies; and
a sixth executable portion for causing the medical reports identified as noncompliant to be displayed.

8. The computer program product of claim 7, wherein the fourth executable portion comprises comparing the relevant data with the provisions using natural language processing techniques embedded in an extensible markup language (XML) framework.

9. The computer program product of claim 7, wherein the clinical guideline is represented in an extensible markup language (XML) framework.

10. The computer program product of claim 7, wherein a contraindication is a condition requiring deviation from the provisions set forth in the clinical guideline.

11. The computer program product of claim 7, wherein the step of causing the medical reports to be displayed comprises providing an user with display options for displaying the medical reports.

12. The computer program product of claim 11, wherein the display options comprises i) displaying the noncompliant medical reports, or ii) displaying all of the medical reports with an associated tag indicating whether the medical report is noncompliant or not.

13. A method of determining patient medical conditions by evaluating data in medical reports, comprising:
searching data in medical reports stored in a storage device using a selected group of words to identify at least one or more concepts;
extracting data from medical reports stored in a storage device;
determining the context of the identified concept;
tagging identified concepts with a qualifier to characterize the context of the concept;
applying a set of rules to the data to determine medical conditions when a concept has not been identified;
determining the medical condition based on the results of searching, determining and tagging or based on the result of application of the rules; and
displaying the medical condition and the medical report as the result.

14. The method of claim 13, wherein the context of the identified concept is determined by searching for selected words used to establish the context of the concept within a sentence fragment of any of the selected group of words.

15. The method of claim 13, wherein a concept is represented as a collection of terms which are synonymous with a medical condition.

16. The method of claim 13, wherein a qualifier is any one of negated, hypothetical, historical, pertaining to relatives of patient, or natively true in the current time frame.

17. The method of claim 13, wherein the medical report is a discharge summary.
